(19) United States
(12) Patent Application Publication
(10) Pub. No.: US 2020/0117721 A1
(43) Pub. Date: Apr. 16, 2020

(54) Modeling Method For Data Archival

(71) Applicant: Cigna Intellectual Property, Inc., Wilmington, DE (US)

(72) Inventor: Jeffrey Richard McCormick, Cheshire, CT (US)

(73) Assignee: Cigna Intellectual Property, Inc., Wilmington, DE (US)

(21) Appl. No.: 16/156,590

(22) Filed: Oct. 10, 2018

(51) Int. Cl. G06F 17/30

(52) U.S. Cl. CPC G06F 17/30073; G06F 17/30607

(57) ABSTRACT

Multiple source computer systems each store data and at least one of the source computer systems stores the data in a structure and format that is different from the structure and format in which at least one of the other source computer systems stores the data. Data is extracted from the source computer systems and the extracted data is stored in an archive data storage system in accordance with an industry specific model. The industry specific model includes at least one data object where each data object comprises metadata and a payload. The metadata is the same for each of the plurality of source computer systems and the payload is different for at least one of the plurality of source computer systems.

### FIELD OF THE INVENTION

The invention relates to electronic long term data archival.

### BRIEF SUMMARY OF THE INVENTION

The present invention relates to a system and method for archiving data. A plurality of source computer systems are maintained and each of the source computer systems store data. At least one of the plurality of source computer systems stores the data in a first structure and format and at least one other of the plurality of source computer systems stores the data in a second structure and format. The first structure and format is different from the second structure and format. Data is extracted from the plurality of source computer systems. The extracted data is stored in an archive data storage system in accordance with an industry specific model. The industry specific model includes at least one data object. Each data object comprises metadata and a payload. The metadata is the same for each of the plurality of source computer systems and the payload is different for at least one of the plurality of source computer systems.

### BRIEF DESCRIPTION OF THE DRAWINGS

The foregoing summary, as well as the following detailed description of embodiments of the invention, will be better understood when read in conjunction with the appended drawings of an exemplary embodiment. It should be understood, however, that the invention is not limited to the precise arrangements and instrumentalities shown.

In the drawings:

FIG. 1 is an exemplary object model of the present invention;

FIG. 2 is an exemplary data object of the present invention;

FIG. 3 is an example system of the present invention; and

FIG. 4 is flow chart illustrating an exemplary system and method of the present invention; and

FIG. 5 is a flow chart illustrating an exemplary system and method of the present invention.

### DETAILED DESCRIPTION OF THE EXEMPLARY EMBODIMENTS

Existing data archive systems typically comprise an online archive for inactive data. The data maintained in such archive is not accessible from the application that is the source of the data. The data structure of such archives is identical to that of the source (e.g., a subsetted data model). The data stored in such systems may be periodically appended from the source. These data archive solutions offer a fast time to market and provide immediate relief to the source system in terms of performance, availability and management

However, such existing systems are limited in a number of ways. Notably, such systems involve replicating the source system data model for the archive, which presents a number of disadvantages once the source system becomes outdated or non-existent. Complex, normalized and sometimes proprietary data models are understood by a select few experts, and perhaps become non-existent as source systems are eventually replaced or simply shutdown. Typically, archives which use source system schemas must evolve the archive schemas each time the source schema is changed or deal with a new version of the schema at each change.

Further, even when the system is in use, certain disadvantages may exist. For example, the source system may require source system application metadata, rules or configurations to make sense of the data—this would not be available in the archive—the archive would consist of a random collection of unintelligible data. Archive data, using the source system data format, may encounter a proprietary format that requires vendor specific products to manage the data and a limited, perhaps proprietary set of data access methods and tools. Archiving data, in isolation, at the system level prevents centralized enterprise management and is difficult to access and secure.

As source system data identified for archive ages beyond its useful operational life, it should be archived to a separate archive platform for the remainder of its legal retention life, potentially outliving the source system itself. The long term data archive system and method of the present invention provide a generic architecture for centralized long term data retention.

In accordance with the present invention, an archive system is provided that is superior to existing archive solutions. More particularly, in one embodiment, the present invention provides a generic and flexible modeling method for data archival. In connection with embodiments of the present invention, any industry business model may be represented in a meta-model of generic business classes with schema-less business structures, either as a stand-alone or connected system archive. In one embodiment, source system archive data is tagged and linked to business classes. Business data may be stored as business objects in a flexible, system-independent format.

Embodiments of the present invention involve an enterprise archive system that may be comprised of disparate systems connected with enterprise master data management structures. In accordance with embodiments of the present invention, an enterprise data model is not used and, instead, the data structure is object-based. The archive system is designed such that the complexity of the source system is decoupled and the data model is simplified through de-normalizing and flattening techniques. Such archive provides an effective long term retention for inactive data that has been identified for archive. A common user interface can be used for searching and retrieving data associated with all source systems, thereby making the data available for historical customer inquiry, legal compliance and other uses such as analytics.

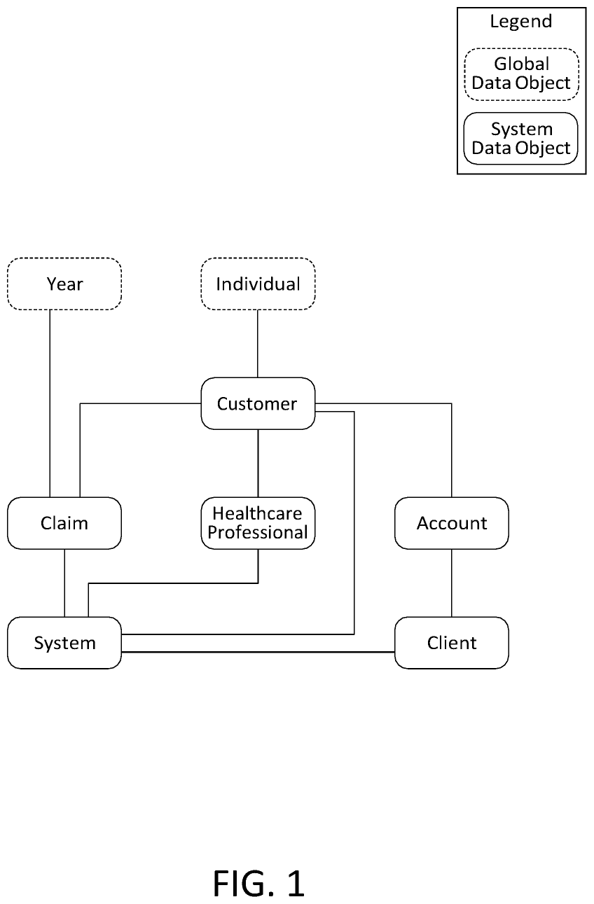

The long term archive system of the present invention employs a class-object meta model, an example of which is shown in FIG. 1. The model shown in FIG. 1 is exemplary only. This exemplary model is one that may be applicable in the health insurance industry. As will be understood by those skilled in the art, the present invention may be applicable to data generated by any industry; furthermore, the invention may use many meta models for different aspects of its data—one for each industry. As illustrated in FIG. 1, the customer may be associated with a health care provider (e.g., primary physician) and an account. The customer may have made one or more heath care insurance claims for a given provider, and data regarding the same may be processed and stored by a particular system. Similar data may be used in several of the organization's applications/systems. The data from all such applications/systems may be organized in accordance with the model.

In one embodiment, the long term archive meta-models, one for each industry, simplify and connect dissimilar systems at an enterprise level. A de-normalized, flattened meta-model may decouple the simple and intuitive archive structure from the complexity of source system data schemas, eliminating the need to understand the plurality of source computer system models. Source system data structures, particularly transaction systems, may have a normalized data model optimized for additions, deletions, and modifications of data; increased separation and isolation of data (e.g., more tables, relationships) and increasing complexity may result. In one embodiment, the archive, which is immutable, is a de-normalized data model optimized for reading data. The result may be that data is collapsed or flattened into a small number of objects—simplified and intuitive. A single meta-model enables legal and customer investigatory inquiry users to access archive data, across all systems, without requiring knowledge of each source system's unique data schema and schema evolution. By centralizing and connecting dissimilar data, the archive may become a single-copy, multi-purpose data store, supporting other use cases and opportunities of actionable insights, such as analytics.

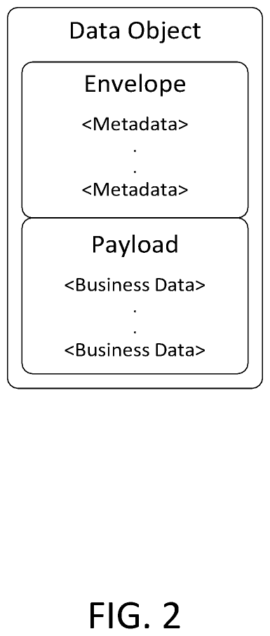

In one embodiment, the long term archive employs an object-based approach to manage, store and relate dissimilar data within a centralized enterprise archive. The structure of the data object is illustrated in FIG. 2. In an exemplary embodiment, there are two classes of data objects: System Objects and Global Objects. System Objects, sourced from individual application systems, contain business data. Global Objects, sourced from enterprise master data sources, provide a key used to connect selected System Objects and provide an enterprise view, acting as the glue connecting the plurality of source computer system archives.

In one embodiment, data objects have a consistent structure, comprising a meta-data envelope and a business data payload, as shown in FIG. 2. In one embodiment, the meta-data envelope is used by the archive system to manage the data object. In one embodiment, the envelope (metadata) is the same format for all object classes, regardless of industry. In one embodiment, the immutable business data payload format is a schema-less, flexible format that is specific to the source system. In one embodiment, this eliminates the complexity of schema evolution and is used for data retention and inquiry.

For example, in the healthcare industry, source systems A and B may be mapped to a “Customer” archive object class. In one embodiment, the format (data fields) of the object envelope is the same for both source systems. However, the format (data fields) of the object payload may be different, i.e., specific to the individual source system's data attribution. By way of further example, in the healthcare industry, there is a “Claim” object class. Data for a single claim stored in many source tables is archived into a single claim object instance, in accordance with the “Claim” object class.

One important technical advantage of the present invention is that structures of the source data may vary between the plurality of source systems. For example, the archive payload may be any format i.e. XML, JSON, etc. In one embodiment, this is transparent to the user as all data is presented in a relational format through the use of views. The archive access layer abstracts the payload format from the access format by placing a relational view over the payload for SQL based access. Another important aspect may be that use of a single industry object class model with global class objects allows for a connected, cross-system enterprise archive with the flexibility of source system specific business data attribution by virtue of schema-less object payloads. Such a system enables querying and centrally managing archive data across systems. The use of master global data objects, e.g., an individual who is linked to each system's customer data object, provide a connection among systems. Further, global object classes connect dissimilar archive systems providing departmental, enterprise, and other views. No enterprise archive data attribute model is required; the business data format is schema-less at the system level. The extensible and incremental object model may allow for evolution over time rather than an extensive up front activity associated with archiving. The open and portable architecture allows for technology agnostic implementations. The flexible business data structure supports archival of structured, semi-structured and unstructured data.

Each periodic system archive, grouped into an archive package, is independent of any other for that system. Each package is a wholly contained archive, requiring no references to other packages or data objects in the long term archive. An archive package provides a current point-in-time view of the source system data structure; this does not require previous archive packages to be “updated” if the source system data structure changes. As source systems data structure evolve overtime, no changes occur to the existing archive. This simplifies and ensures point-in-time historical integrity.

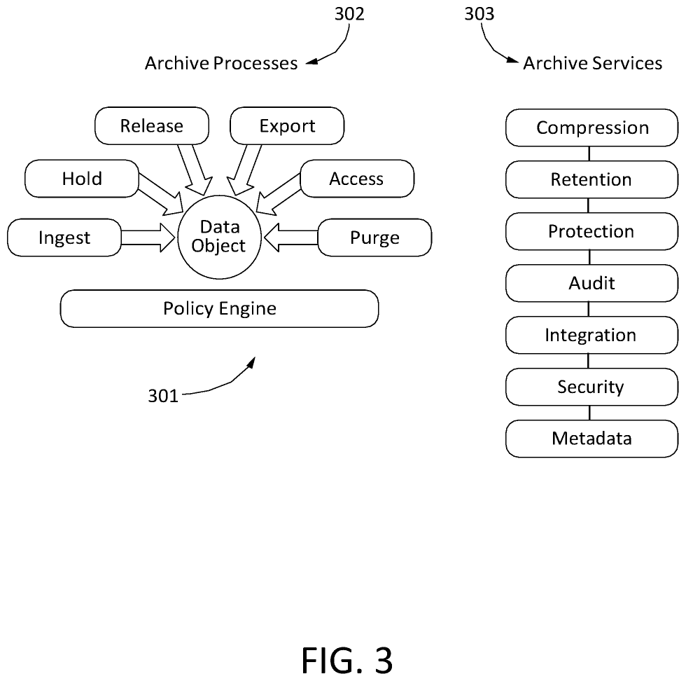

The components of the long term archive, in an exemplary embodiment, are now described, with reference to FIG. 3. A policy engine 301 may be comprised of a computer processor. Policy engine 301 may serve as a secure and automated means to codify a set of rules and management processes around archived data. As such, the policy engine 301 may have rules to manage the data throughout the remainder of its life cycle. For example, retention policies may be codified in the policy engine 301 and used to determine when to eventually purge the data from the archive by interrogating an objects metadata envelop. Claims for a particular system data may be purged after 15 years while other object data may be purged on a different schedule. The policy engine 301 may provide an automated process to manage archive data. Archive Processes 302, examples of which are shown, may take actions on the archived data throughout its lifecycle in the long term archive, starting with ingestion and ending with removal. Archive services 303 may provide a secure, accessible, compliant and efficient archive platform Archive services 303 may provide a set of independent actions a user can take on the data in the archive. Ingestion may be defined as an automated load process to bring extracted source system data in the archive. Hold may be defined as an automated process to flag data and/or prevent purging. Hold may be initiated/requested by legal services in anticipation of or during litigation. Release may be defined as an automated process to un-flag data, allowing purging. Release may be initiated and/or requested by legal services after litigation. Export may be defined as an ability to extract data from the archive into a desired format. Export may occur in bulk and/or in singleton query. Purge may be defined as an automated process to remove data from the archive. Purge may occur in conjunction with the policy engine.

An example of the data extraction process is now described in more detail. Data extraction may provide a means to transform and organize the complex source data into the archive objects of the industry model. In one embodiment, the extract design goals are to emphasize simplicity, generality, and durability (e.g., usability over time), in a format that is both human-readable and machine-readable. Separate extracts may be created for each data item of interest. For example, in the insurance context, the extracts may include policy; money; claim; and party data. In an exemplary embodiment, the extract format is Extensible Markup Language (XML). Each XML extract has an XML Schema (e.g., XSD file) defining the structure of the extract. In one embodiment, each extract is comprised of one or more files, if needed for size constraints. The content of the extract includes selected business data from the source system; primary and foreign key identifiers; and de-coded values from the source system.

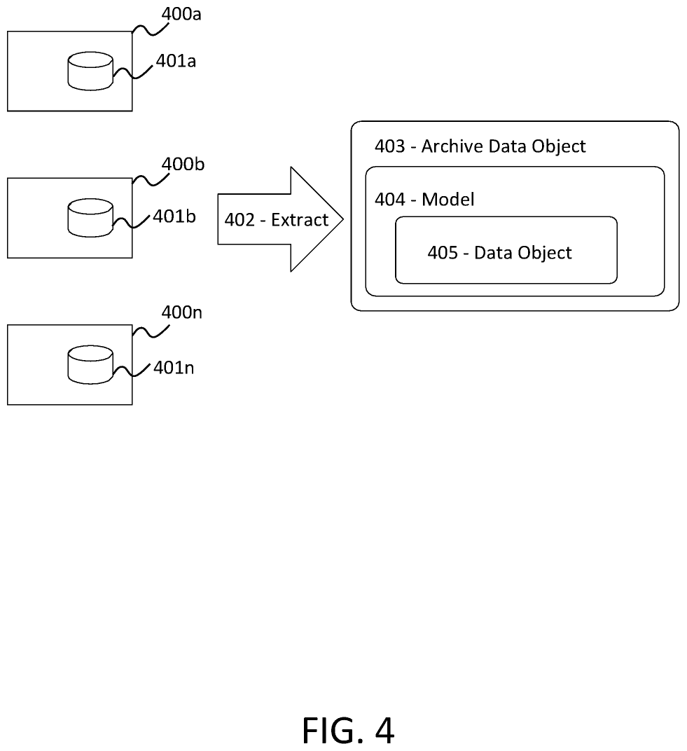

FIG. 4 illustrates an exemplary system for carrying out the methods of the present invention. A plurality of source computer systems 400a, 400b, . . . 400n may be maintained. Each of the source computer systems may store data 401a, 401b, . . . 401n. In one embodiment, at least one of the plurality of source computer systems stores the data in a first structure and format and at least one other of the plurality of source computer systems stores the data in a second structure and format. The first structure and format may be different from the second structure and format. Data may be extracted by a computer processor 402, from the plurality of source computer systems. In one embodiment, the extracted data is stored in an archive data storage system 403 in accordance with an industry specific model. In one embodiment, extracted data is stored in an archive data storage system 403 in accordance with a simplified industry specific model. The industry specific model 404 (e.g., as illustrated in FIG. 1) includes at least one data object 405 (e.g., as illustrated in FIG. 2). In one embodiment, each data object comprises metadata and a payload. In one embodiment, the metadata is the same for each of the plurality of source computer systems and the payload is different for at least one of the plurality of source computer systems.

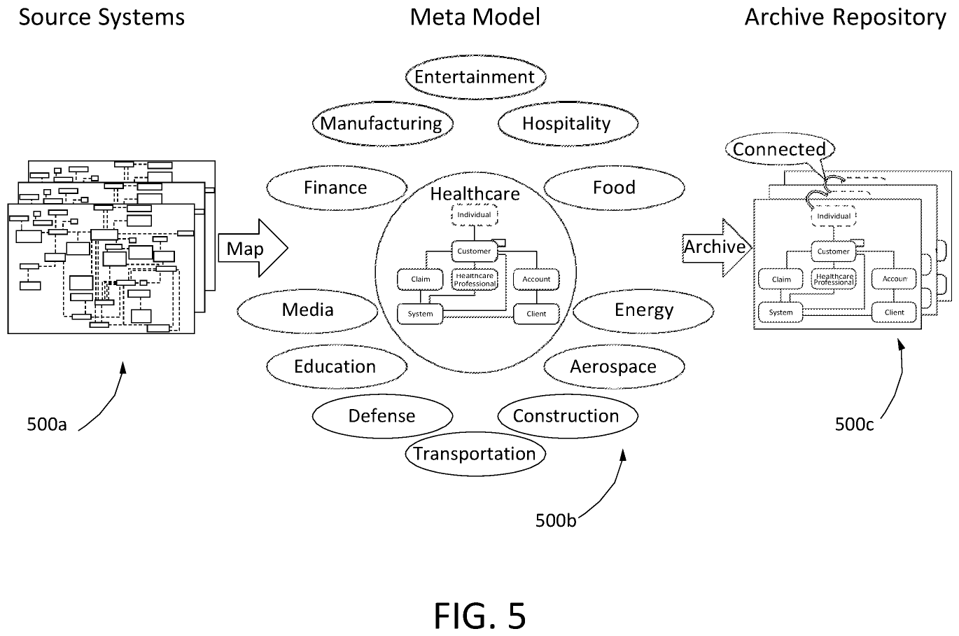

FIG. 5 illustrates an exemplary system for carrying out the methods of the present invention. A plurality of source systems 500a may be maintained. Each of the source systems 500a may store data. In one embodiment, at least one of the plurality of source computer systems stores the data in a first structure and format and at least one other of the plurality of source systems stores the data in a second structure and format. The first structure and format may be different from the second structure and format. Data may be mapped by a computer processor from the plurality of source systems 500a to meta model 500b. In one embodiment, the mapped data is stored in an archive repository, 500c in accordance with an industry specific model.

The present invention may reflect an improvement to computer systems and technology. The present invention may result in improvements in data storage associated with a long term data archive system, achieving a number of benefits as described more fully herein. De-normalized, flattened archive industry object class models may be simple and intuitive. Industry object class models may decouple the archive from the complexity of unique source system schemas. Global object classes may connect dissimilar archive systems providing departmental, enterprise and other views. Business data formats may be schema-less at the system level. Separate archive object models may remove the need to deal with the evolution of source system schemas. Extensible and incremental object models may allow for an evolution over time rather than an extensive up front activity. Multi-purpose archives may support other use cases and/or opportunities of actionable insights. Open and portable architecture may allow for technology agnostic implementations. Flexible business data structures may support structured, semi-structured and unstructured data.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A computer implemented method, comprising:
maintaining a plurality of source computer systems, each of the source computer systems storing data, wherein at least one of the plurality of source computer systems stores the data in a first structure and format and at least one other of the plurality of source computer systems stores the data in a second structure and format, wherein the first structure and format is different from the second structure and format;
extracting the data from the plurality of source computer systems; and
storing the extracted data in an archive data storage system in accordance with an industry specific model,
wherein the industry specific model comprises at least one data object, wherein each data object comprises metadata and a payload, wherein the metadata is the same for each of the plurality of source computer systems and the payload is different for at least one of the plurality of source computer systems.

2. A computer system, comprising:
a plurality of source computer systems, each of the source computer systems storing data in a data storage repository, wherein at least one of the plurality of source computer systems stores the data in a first structure and format and at least one other of the plurality of source computer systems stores the data in a second structure and format, wherein the first structure and format is different from the second structure and format;
a computer processor configured to extract the data from the plurality of source computer systems; and
an archive data storage system configured to store the extracted data in accordance with an industry specific model,
wherein the industry specific model comprises at least one data object, wherein each data object comprises metadata and a payload, wherein the metadata is the same for each of the plurality of source computer systems and the payload is different for at least one of the plurality of source computer systems.
